(19) United States
(12) Patent Application Publication
(10) Pub. No.: US 2026/0319411 A1
(43) Pub. Date: Oct. 15, 2026

(54) IMAGE FORMING APPARATUS

(71) Applicant: CANON KABUSHIKI KAISHA, Tokyo (JP)

(72) Inventor: HIROSHI TOMII, Chiba (JP)

(21) Appl. No.: 19/635,018

(22) Filed: Mar. 31, 2026

(30) Foreign Application Priority Data
Apr. 10, 2025 (JP) 2025-065002

(51) Int. Cl. G03G 15/00; G03G 15/08

(52) U.S. Cl. CPC G03G 15/5058; G03G 15/0848; G03G 15/0865; G03G 2215/00059

(57) ABSTRACT

An image forming apparatus includes an image forming unit which includes a developing device configured to store developer including toner and carriers, the developing device being configured to form an image using the toner of the developing device, a detector which is provided in the developing device, the detector being configured to detect a toner density of the developer in the developing device, an image reader configured to read a test image formed by the image forming unit, a mounting unit to which a toner container storing toner to be supplied to the developing device is to be mounted, and a processor configured to adjust, in a case where the toner container is mounted to the mounting unit, an image forming condition for controlling a density of an image to be formed by the image forming unit before image formation based on a job is started.

### BACKGROUND

### Field of the Technology

The present disclosure relates to an image forming apparatus, such as a printer, a copying machine, or a multifunction peripheral.

### Description of the Related Art

There are image forming apparatus which print an image through use of, for example, two-component developer in which toner and carriers are mixed at a predetermined mixing ratio. The toner of the two-component developer is stored in a developing device. In order to maintain charging characteristics of the toner in the developing device, toner is supplied to the developing device from a toner container such as a toner bottle. When toner for replenishment has run out in the toner container, the toner container is replaced with a new toner container. The image forming apparatus can determine a remaining amount of toner in the toner container based on, for example, a value of a toner density sensor in the developing device. The toner density sensor detects a TD ratio representing a toner density of the two-component developer in the developing device.

The TD ratio takes a lower value when toner in the toner container has run out than when the toner is present. A reduction amount of the TD ratio at the time when the toner in the toner container is determined to have run out varies depending on an amount of toner consumed by printing immediately before the toner is determined to have run out.

In Japanese Patent Application Laid-open No. 2018-87997, there is disclosed an image forming apparatus which limits a toner supply amount supplied immediately after the toner container (toner bottle) is replaced to a value lower than a toner supply amount in the normal case. With such control, the rise of the TD ratio immediately after the toner container is replaced becomes gentler, and the variations in toner density in the developing device are reduced. In Japanese Patent Application Laid-open No. 2007-78896, there is disclosed an image forming apparatus which controls a developing contrast and controls a toner supply operation in accordance with a detection result (TD ratio) obtained by the toner density sensor in the developing device and a detection result (image density) of an image formed on an image bearing member obtained by an image reader. This image forming apparatus adjusts the developing contrast when the TD ratio and the image density are out of a predetermined range, to thereby suppress variations in image density with respect to variations in TD ratio.

In Japanese Patent Application Laid-open No. 2018-87997, abrupt variations in toner density in the developing device are suppressed by moderating the rise of the TD ratio by controlling the toner supply amount supplied after the toner container is replaced. Accordingly, the image forming apparatus of Japanese Patent Application Laid-open No. 2018-87997 cannot cope with a change in TD ratio that cannot be followed by the control of the toner supply amount. In Japanese Patent Application Laid-open No. 2007-78896, the variations in toner density in the developing device that cannot be followed by the control of the toner supply amount are coped with by adjusting the developing contrast based on the actually measured image density. However, the developing contrast cannot be adjusted until the detection result of the image density is acquired.

Accordingly, in the technologies as disclosed in Japanese Patent Application Laid-open No. 2018-87997 and Japanese Patent Application Laid-open No. 2007-78896, the TD ratio is in a state of greatly deviating from a target value in the following cases. The first case is a case in which an image having a high image area ratio is printed immediately before toner in the toner container is determined to have run out, and thus the TD ratio has become greatly lower than the target value after the toner container is replaced. The second case is a case in which toner is oversupplied from the toner container immediately after the toner container is replaced, and thus the TD ratio in the developing device has become greatly larger than the target value. There is also a case in which an image is formed after the same toner container is removed and inserted, and hence there is a possibility that toner oversupply occurs not only at the time of replacement of the toner container but also at the time of mounting the toner container. In both of the first case and the second case, an abrupt change in toner density (TD ratio) causes difficulty in maintaining the image density of the printed image to a target image density.

### SUMMARY

An image forming apparatus according to some embodiments of the present disclosure includes an image forming unit which includes a developing device configured to store developer including toner and carriers, the developing device being configured to form an image using the toner of the developing device, a detector which is provided in the developing device, the detector being configured to detect a toner density of the developer in the developing device, an image reader configured to read a test image formed by the image forming unit, a mounting unit to which a toner container storing toner to be supplied to the developing device is to be mounted, and a processor configured to, adjust, in a case where the toner container is mounted to the mounting unit, an image forming condition for controlling a density of an image to be formed by the image forming unit before image formation based on a job is started, control, in a case where the toner container is mounted to the mounting unit, whether to form the test image based on the toner density detected by the detector after the image formation based on the job is started, and update the image forming condition based on a reading result of the test image read by the image reader.

An image forming apparatus according to some embodiments of the present disclosure includes an image forming unit which includes a developing device configured to store developer including toner and carriers, the developing device being configured to form an image using the toner of the developing device, a detector which is provided in the developing device, the detector being configured to detect a toner density of the developer in the developing device, an image reader configured to read a test image formed by the image forming unit, a mounting unit to which a toner container storing toner to be supplied to the developing device is to be mounted, and a processor configured to, control, in a case where the toner container is mounted to the mounting unit, the image forming unit to form the test image before image formation based on a job is started, control the image forming unit to form an image for detection, and detect the toner density of the developer in the developing device based on a reading result of the image for detection read by the image reader, and adjust an image forming condition for controlling a density of an image to be formed by the image forming unit based on a reading result of the test image read by the image reader.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view of an image forming apparatus.

FIG. 2 is a configuration view of an image forming unit.

FIG. 3 is a configuration view of an image reading device.

FIG. 4 is a configuration view of a control unit.

FIG. 5 is a configuration view of an image reader.

FIG. 6 is a configuration view of a developing device.

FIG. 7 is an explanatory view of ATR control.

FIG. 8 is a flow chart for illustrating initialization control processing of the developing device.

FIG. 9 is an explanatory diagram of a toner supply amount controller.

FIG. 10 is an explanatory diagram of a toner supply amount.

FIG. 11 is an explanatory graph of a change in toner density exhibited when toner is oversupplied.

FIG. 12 is an explanatory graph of a TD ratio at the time when a toner container is determined to be empty.

FIG. 13 is a flow chart for illustrating determination processing of determining whether or not to perform image adjustment control.

FIGS. 14A and 14B are explanatory graphs of effects obtained by a first embodiment of the present disclosure.

FIG. 15 shows explanatory graphs of transitions of the TD ratio and an image density after the toner container is replaced.

FIG. 16 is a flow chart for illustrating determination processing of determining whether or not to perform image adjustment control.

FIG. 17 shows explanatory graphs of effects obtained by a second embodiment of the present disclosure.

### DESCRIPTION OF THE EMBODIMENTS

Now, referring to the accompanying drawings, description is given of exemplary embodiments of the present disclosure.

### First Embodiment

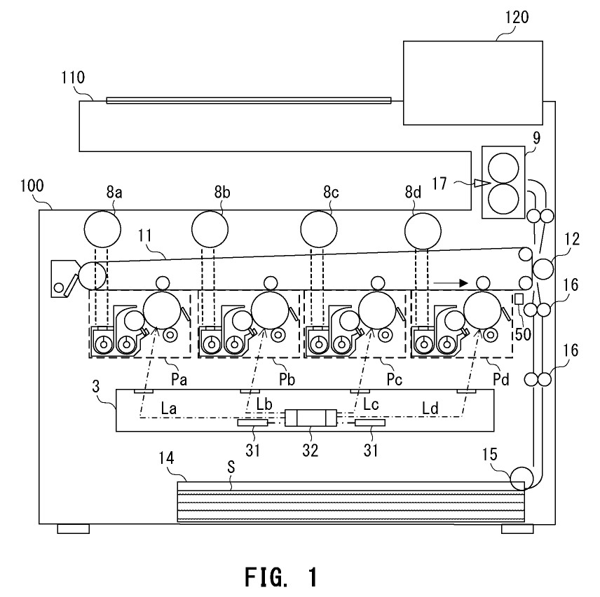

FIG. 1 is a configuration view of an image forming apparatus of a first embodiment of the present disclosure. An image forming apparatus 100 of the first embodiment is an electrophotographic color multifunction peripheral adopting a contact charging system and a two-component contact developing system. The image forming apparatus 100 includes, at an upper portion thereof, an image reading device 110 and an operation unit 120. The operation unit 120 is a user interface including an input interface and an output interface. The image forming apparatus 100 prints an image on a sheet S in accordance with instructions, settings, or the like input from the operation unit 120. The image forming apparatus 100 displays setting screens or messages through the operation unit 120. The image reading device 110 reads an image from an original to generate image data representing the read image.

The image forming apparatus 100 includes an exposing device 3, a plurality of (in the first embodiment, four) image forming units Pa, Pb, Pc, and Pd, an intermediate transfer belt 11, a secondary transfer roller 12, and a fixing device 9. The exposing device 3 includes two light sources 31 and one rotary polygon mirror 32. The exposing device 3 deflects laser light output from each of the two light sources 31 by the rotary polygon mirror 32 to supply laser light beams La, Lb, Lc, and Ld to the image forming units Pa, Pb, Pc, and Pd, respectively. The image forming unit Pa forms a yellow (Y) toner image based on the laser light beam La. The image forming unit Pb forms a magenta (M) toner image based on the laser light beam Lb. The image forming unit Pc forms a cyan (C) toner image based on the laser light beam Lc. The image forming unit Pd forms a black (K) toner image based on the laser light beam Ld. The image forming units Pa, Pb, Pc, and Pd consume toner when the toner images are formed. The image forming apparatus 100 includes a mounting unit (not shown) to which toner containers 8a, 8b, 8c, and 8d storing toner are mountable to supply toner to the image forming units Pa, Pb, Pc, and Pd. In the following description, in a case where the color of the toner is not required to be distinguished, description is given with "a", "b", "c", and "d" at ends of the reference symbols being omitted.

The toner images of the respective colors formed by the respective image forming units Pa, Pb, Pc, and Pd are transferred onto the intermediate transfer belt 11 in a superimposed manner. The intermediate transfer belt 11 is an image bearing member for bearing the toner images of the respective colors transferred from the respective image forming units Pa, Pb, Pc, and Pd. The intermediate transfer belt 11 is rotated in the direction of the arrow to convey the borne toner images of the respective colors to the secondary transfer roller 12.

The image forming apparatus 100 includes a sheet cassette 14 for storing sheets S, a feed roller 15 for feeding the sheet S, and a plurality of conveyance roller pairs 16. The feed roller 15 supplies the sheets S one by one from the sheet cassette 14 to a conveyance path. The plurality of conveyance roller pairs 16 convey the sheet S supplied to the conveyance path to the secondary transfer roller 12. The conveyance roller pair 16 closest to the secondary transfer roller 12 conveys the sheet S to the secondary transfer roller 12 in synchronization with the timing at which the toner images borne on the intermediate transfer belt 11 are conveyed to the secondary transfer roller 12.

The secondary transfer roller 12 abuts against the intermediate transfer belt 11 to form a secondary transfer nip. When the sheet S passes through the secondary transfer nip, the toner images are transferred from the intermediate transfer belt 11 onto the sheet S. The secondary transfer roller 12 conveys the sheet S having the toner images transferred thereon to the fixing device 9. The fixing device 9 fixes the toner images transferred onto the sheet S. In the manner described above, an image is printed on the sheet S. The sheet S having the image printed thereon is, for example, discharged to the outside of the image forming apparatus 100 by a discharge unit 17 including a discharge roller pair.

In the vicinity of the intermediate transfer belt 11, an image reader 50 is arranged between the image forming units Pa to Pd and the secondary transfer roller 12. The image reader 50 is used to detect an image density (optical density) of a toner image borne by the intermediate transfer belt 11. For example, the image forming apparatus 100 uses the image reader 50 to detect an image density from a test image for detecting the image density. The image forming apparatus 100 adjusts image forming conditions based on the detected image density. That is, the image forming conditions are adjusted such that the image density of the image to be formed on the sheet S becomes a target image density (target value). Examples of the image forming conditions to be adjusted for image density control include an exposure amount, a charging bias voltage, a developing bias voltage, and a developing contrast.

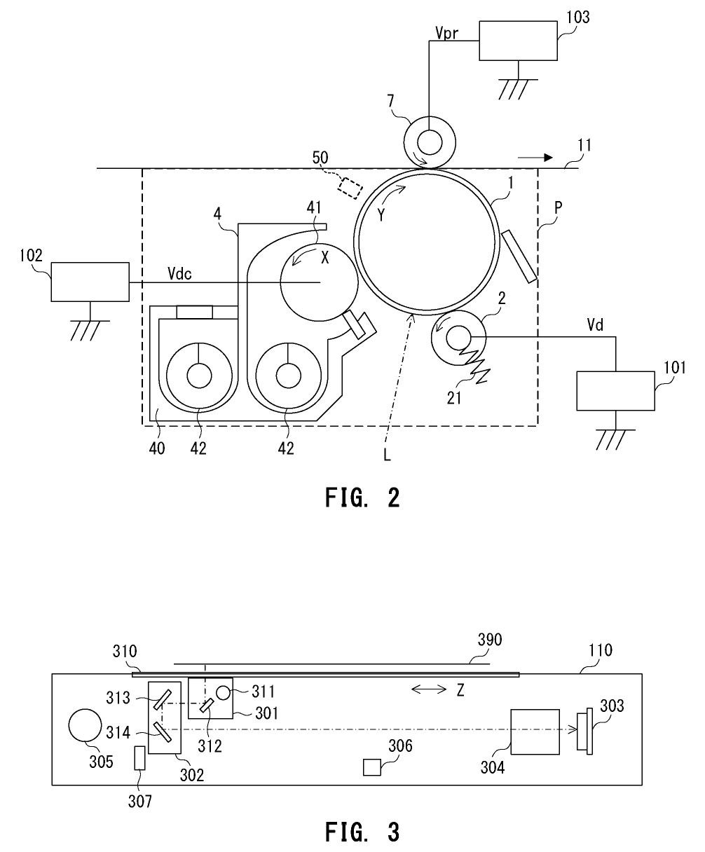

FIG. 2 is a configuration view of the image forming unit Pa, Pb, Pc, or Pd. The image forming units Pa, Pb, Pc, and Pd have similar configurations, and form toner images by similar operations. In this case, the image forming unit is described as an image forming unit P without distinguishing the colors of the toner images to be formed. The image forming unit P includes a photosensitive drum 1, a charging roller 2, a developing device 4, and a primary transfer roller 7. The photosensitive drum 1 is a drum-shaped photosensitive member including a photosensitive layer on its surface, and is rotatable in the direction of an arrow Y about a drum shaft. Around the photosensitive drum 1, in order from an upstream side in the direction of the arrow Y, the charging roller 2, the developing device 4, and the primary transfer roller 7 are arranged. The laser light L exposes the surface of the photosensitive drum 1 between the charging roller 2 and the developing device 4. The photosensitive drum 1 is an image bearing member for bearing a toner image formed by the charging roller 2, the exposing device 3, and the developing device 4.

The charging roller 2 is a charging device to which a charging bias voltage Vd is applied from a high-voltage power supply 101 to uniformly charge the surface of the photosensitive drum 1. The charging roller 2 has a core metal whose both end portions are each rotatably held by a bearing member (not shown). Both end portions of the core metal of the charging roller 2 are biased in the direction toward the photosensitive drum 1 by pressure springs 21. That is, the charging roller 2 is brought into pressure contact with the surface of the photosensitive drum 1 with a predetermined pressing force. In this manner, the charging roller 2 is rotated in association with the rotation of the photosensitive drum 1. The charging bias voltage Vd is, for example, an oscillating voltage obtained by superimposing a DC voltage and an AC voltage. The waveform of the AC voltage is, for example, a sine wave. The frequency of the AC voltage is 1.3 kHz. A peak-to-peak voltage Vpp of the AC voltage is 1.5 kV. The DC voltage is, for example, −600 V. In this case, the surface potential of the photosensitive drum 1 becomes −600 V (dark potential), which is the same as the DC voltage applied to the charging roller 2.

The uniformly charged surface of the photosensitive drum 1 is irradiated with the laser light L emitted from the exposing device 3. The exposing device 3 irradiates the surface of the photosensitive drum 1 with the laser light L modulated in accordance with image data to form an electrostatic latent image corresponding to the image data on the surface of the photosensitive drum 1. The image data is input from the image reading device 110 or an external device such as a personal computer.

The developing device 4 causes toner to adhere to the electrostatic latent image to perform reversal development of the toner image. The developing device 4 includes a developer container 40 for storing toner, stirring screws 42 for stirring the toner and carriers, and a developing sleeve 41 arranged to be opposed to the photosensitive drum 1. The developer container 40 stores, for example, two-component developer in which non-magnetic toner and magnetic carriers are mixed with a predetermined mixing ratio. A developing bias voltage Vdc is applied from a high-voltage power supply 102 to a core metal of the developing sleeve 41. The developing bias voltage Vdc is a voltage for developing the electrostatic latent image.

The non-magnetic toner used in the developing device 4 has, for example, a negative polarity. The developing sleeve 41 is a non-magnetic developer carrying member, and rotates in the direction of an arrow X. A part of an outer peripheral surface of the developing sleeve 41 is exposed to the outside of the developing device 4 to be opposed to the photosensitive drum 1. The closest distance (S-D gap) between the developing sleeve 41 and the photosensitive drum 1 is, for example, 260 μm. The electrostatic latent image formed on the photosensitive drum 1 is developed at a position opposed to the developing sleeve 41. An opposing portion between the photosensitive drum 1 and the developing sleeve 41 is also called a developing portion.

The developing bias voltage Vdc is an oscillating voltage obtained by superimposing a DC voltage and an AC voltage. The DC voltage is, for example, −450 V. The frequency of the AC voltage is 8.0 kHz. The peak-to-peak voltage Vpp of the AC voltage is 1.8 kV. The waveform of the AC voltage is a square wave. The toner is carried from the developing sleeve 41 to the surface of the photosensitive drum 1 by an electric field generated between the developing bias voltage Vdc and the potential on the surface of the photosensitive drum 1, thereby achieving reversal development of the electrostatic latent image.

The toner image developed by the developing device 4 is conveyed through rotation of the photosensitive drum 1 to a primary transfer nip at which the intermediate transfer belt 11 is sandwiched between the primary transfer roller 7 and the photosensitive drum 1. A high-voltage power supply 103 applies a primary transfer bias voltage Vpr to the primary transfer roller 7. With the primary transfer bias voltage Vpr being applied, transfer of the toner image from the photosensitive drum 1 to the intermediate transfer belt 11 is promoted. The primary transfer bias voltage Vpr is a voltage having a positive polarity that is an opposite polarity to a charging polarity (negative polarity) of the toner. For example, the primary transfer bias voltage Vpr is +1 kV.

The image forming unit P may include the image reader 50 for detecting the image density of the toner image formed on the photosensitive drum 1. In this case, the image reader 50 is provided to be opposed to the surface of the photosensitive drum 1 in a range from the developing portion to a position at which the toner image is transferred onto the intermediate transfer belt 11 by the primary transfer roller 7.

FIG. 3 is a configuration view of the image reading device 110. The image reading device 110 includes, in a casing, a first mirror unit 301, a second mirror unit 302, an image sensor 303, a lens 304, a motor 305, a size sensor 306, and a home position sensor 307. A platen 310 is provided on an upper portion of the casing of the image reading device 110. The first mirror unit 301 includes an illumination light source 311 and a first mirror 312. The second mirror unit 302 includes a second mirror 313 and a third mirror 314. The first mirror unit 301 and the second mirror unit 302 are driven by the motor 305 to allow a reciprocating motion in the direction of an arrow Z.

An original 390 is placed on the platen 310 so that a surface having an image printed thereon is directed to the platen 310 side. In a case where an instruction to read the original 390 is given through the operation unit 120 after the original 390 is placed on the platen 310, the motor 305 moves the first mirror unit 301 and the second mirror unit 302 to a home position. The home position sensor 307 detects that the first mirror unit 301 and the second mirror unit 302 have moved to the home position.

After the first mirror unit 301 and the second mirror unit 302 are moved to the home position, the first mirror unit 301 turns on the illumination light source 311 to irradiate a reading surface (surface on which the image has been printed) of the original 390 with light. The first mirror unit 301 and the second mirror unit 302 guide reflected light from the original 390 to the lens 304 by the first mirror 312, the second mirror 313, and the third mirror 314, while moving in the direction of the arrow Z. The lens 304 forms an image of the reflected light on a light receiving surface of the image sensor 303. The image sensor 303 receives the reflected light and converts the reflected light into an electrical signal. With this electrical signal being subjected to predetermined processing, image data representing the image of the original 390 is generated.

### Control Unit

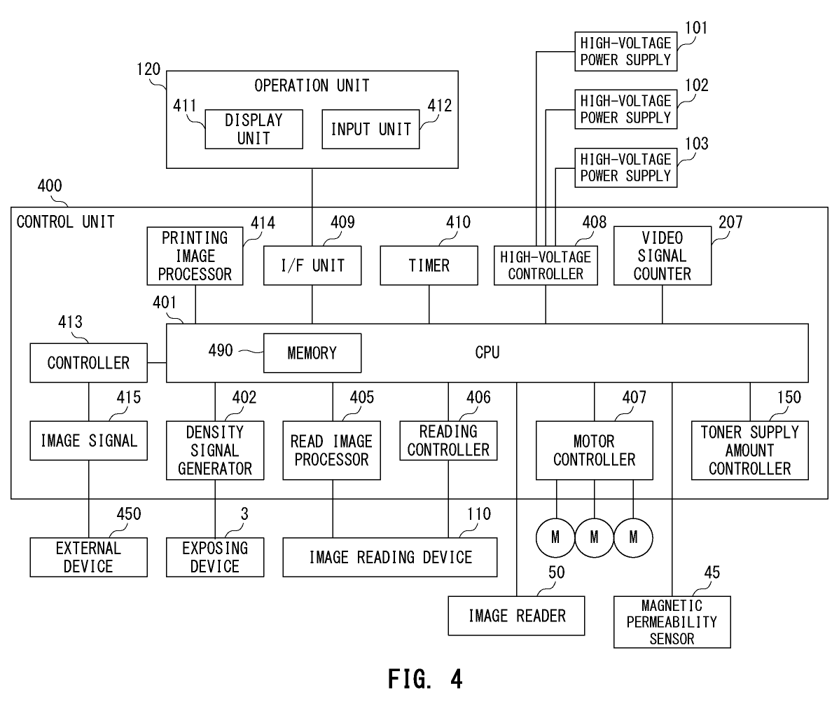

FIG. 4 is a configuration view of a control unit for controlling an operation of the image forming apparatus 100 having such a configuration. A control unit 400 includes a central processing unit (CPU) 401. The CPU 401 executes a control program to control an operation of each unit of the image forming apparatus 100, to thereby print an image onto the sheet S. The CPU 401 includes a memory 490 for storing various types of data. The memory 490 is used also to store identification information of a toner container 8 mounted to the image forming apparatus 100.

To the CPU 401, a density signal generator 402 for controlling the exposing device 3 is connected. The density signal generator 402 converts the image data supplied from a printing image processor 414 to be described later into a density signal (laser control signal) to supply the density signal (laser control signal) to the exposing device 3. The density signal generator 402 also includes a generator for generating a density signal (image data) of a test image to be used for determining image forming conditions that allows a target maximum image density to be achieved. The exposing device 3 drives the light sources 31 to output the laser light beams La to Ld based on the density signal acquired from the density signal generator 402.

To the CPU 401, a reading controller 406 and a read image processor 405 are connected to control the image reading device 110. The reading controller 406 performs control to turn on the illumination light source 311 of the image reading device 110 and control to drive the motor 305 in accordance with a command from the CPU 401. The read image processor 405 acquires the electrical signal from the image sensor 303 of the image reading device 110 to generate an image signal, and transmits the image signal to the CPU 401. The read image processor 405 uses, for example, a lookup table LUTid to convert the electrical signal into an image signal.

To the CPU 401, a motor controller 407 for controlling various motors is connected. The motor controller 407 performs drive control of various motors serving as drive sources of the respective units of the image forming apparatus 100 in accordance with a command from the CPU 401. The motors to be controlled by the motor controller 407 include a motor for driving the feed roller 15, a motor for driving the conveyance roller pairs 16, a motor for driving the image forming unit P, a motor for driving the intermediate transfer belt 11, and a motor for driving the fixing device 9.

To the CPU 401, a high-voltage controller 408 for controlling the high-voltage power supplies 101, 102, and 103 is connected. The high-voltage controller 408 controls the high-voltage power supplies 101, 102, and 103 in accordance with a command from the CPU 401. The high-voltage power supplies 101, 102, and 103 are controlled by the high-voltage controller 408 to output the charging bias voltage Vd, the developing bias voltage Vdc, and the primary transfer bias voltage Vpr, respectively.

To the CPU 401, an I/F unit 409 for performing interface control for communication between the CPU 401 and the operation unit 120, and a timer 410 are connected. The operation unit 120 includes a display unit 411 that is an output interface and an input unit 412 that is an input interface. The display unit 411 is a liquid crystal display, an organic electro-luminescence (EL) display, or the like. The input unit 412 is a keyboard, a touch sensor, or the like. The operation unit 120 may be an external device such as a personal computer connected to the image forming apparatus 100. The timer 410 can be used for measurement of time at the time of performing various types of processing.

To the CPU 401, a controller 413 and the printing image processor 414 are connected. The CPU 401 acquires an image signal 415 via the controller 413. The image signal 415 can be acquired from the image reading device 110 as described above, and can also be acquired from, for example, an external device 450 such as a host computer. The CPU 401 processes the image signal 415 by the printing image processor 414 to generate image data. The image data generated by the printing image processor 414 is transmitted to the density signal generator 402. In this manner, an image can be formed onto the sheet S in accordance with the image signal 415.

The printing image processor 414 performs, for example, processing of expanding the image signal 415 into a bitmap image, or processing (for example, RGB→YMCK) of converting the image signal 415 into a color space. The density signal generator 402 performs correction of a tone characteristic of the image data through use of a tone table (LUT) for correcting a gamma characteristic or binarization of image data through use of a predetermined dither matrix, to thereby generate a laser control signal. The laser control signal is generated for each color of an image to be formed. The exposing device 3 controls emission of the laser light beams La, Lb, Lc, and Ld by the laser control signal.

To the CPU 401, a video signal counter 207 and a toner supply amount controller 150 are connected. The CPU 401 controls the video signal counter 207 to generate a video count value by adding up a pixel value of each pixel of an image represented by the image signal 415 for one page of the image. For example, in a case where the image signal 415 represents an image having a resolution of 600 dpi, the pixel value to be added up is from 0 to 255. For example, in a case where all pixels of an image on one side of an A4 sheet have pixel values of "255," the video count value has the maximum value of "529." The video count value and a detection result obtained by a magnetic permeability sensor 45 to be described later are transmitted to the toner supply amount controller 150. The toner supply amount controller 150 controls supply of toner from the toner container 8 to the developing device 4 of the corresponding image forming unit P based on the video count value and the detection result obtained by the magnetic permeability sensor 45.

To the CPU 401, the image reader 50 and the magnetic permeability sensor 45 are connected. The CPU 401 acquires the detection result from each of the image reader 50 and the magnetic permeability sensor 45 to perform various types of processing. The magnetic permeability sensor 45 is used for detection of the toner amount in the developing device 4 and prediction of a charging amount of the toner.

### Image reader

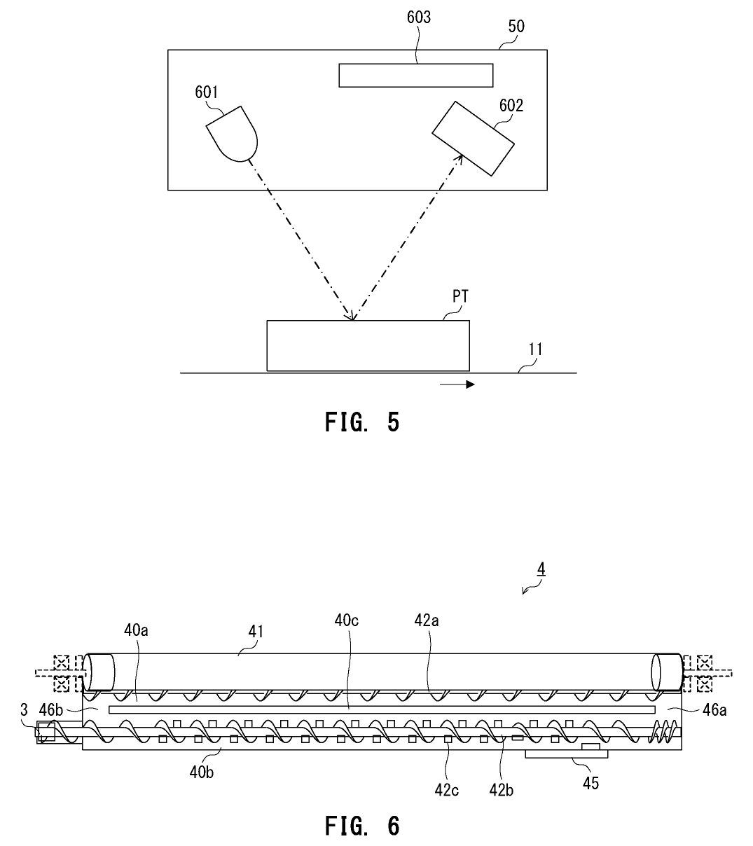

FIG. 5 is a configuration view of the image reader 50. The image reader 50 in the first embodiment is a specular reflection-type optical sensor which detects specularly reflected light from a test pattern PT that is a toner image of a test image formed on the intermediate transfer belt 11. The image reader 50 reads the test pattern PT by detecting the specularly reflected light to output a digital value to be described later that becomes a reading result.

The image reader 50 includes a light emitting element 601, a light receiving element 602, and a sensor controller 603. The light emitting element 601 is a light source for emitting light toward a reading position. The light emitting element 601 is, for example, a light emitting diode. The light receiving element 602 is an element for receiving specularly reflected light from the test pattern PT or the intermediate transfer belt 11 passing through the reading position. The light receiving element 602 is, for example, a photodiode. The sensor controller 603 controls an emission light amount (irradiation light amount) of the light emitting element 601 as one irradiation condition. The sensor controller 603 controls the light emitting element 601 based on an instruction of the CPU 401.

The light emitting element 601 is arranged such that an optical axis thereof forms 45 degrees with respect to a normal line to the intermediate transfer belt 11. The light receiving element 602 is arranged to be line symmetric to the light emitting element 601 with respect to the normal line to the intermediate transfer belt 11. The light receiving element 602 outputs an electric current corresponding to a light reception result (reflected light level). The sensor controller 603 converts the electric current output from the light receiving element 602 into a voltage and further converts the voltage into a digital value (reading result) to transmit the digital value (reading result) to the CPU 401. The digital value is a detection result (output value) obtained by the image reader 50.

FIG. 5 shows, as an example, a case in which the test pattern PT included in the test image passes through the reading position of the image reader 50. The printing image processor 414 includes a conversion table for converting the output value of the image reader 50 into an image density value. The output value includes a luminance value. The CPU 401 uses the printing image processor 414 to convert the output value of the image reader 50 into an image density value. The CPU 401 may hold the conversion table in the memory 490 to convert the output value into an image density value. The conversion table is created in advance in accordance with the output characteristic of the image reader 50, and is stored in advance in the memory in the printing image processor 414 or the memory 490.

The image reader 50 may be a diffused reflection-type optical sensor which receives diffused reflected light. The specular reflection-type optical sensor can detect the toner images of yellow, magenta, cyan, and black. However, the specular reflection-type optical sensor is decreased in detection accuracy as the density signal of the test pattern PT comes closer to 100%. The diffused reflection-type optical sensor can detect the toner images of yellow, magenta, and cyan even when the density signal is 100%. However, the diffused reflection-type optical sensor cannot detect a black toner image. Accordingly, the image reader 50 ideally includes both of the specular reflection-type optical sensor and the diffused reflection-type optical sensor. Such an image reader 50 can detect the test patterns PT of yellow, magenta, cyan, and black with high accuracy even when the density signal is 100%.

### Adjustment of Image Forming Conditions

In general, the adjustment of the image forming conditions is roughly divided into maximum density control and tone correction control. The maximum density control is control of adjusting the developing contrast Vc by adjusting an exposure amount LPW, the charging bias voltage Vd, the developing bias voltage Vdc, and the like. The tone correction control is control of correcting the image data through use of a tone table (LUT) for correcting the gamma characteristic. Here, the developing contrast Vc refers to a potential difference between a potential of a part of the photosensitive drum 1 on which the electrostatic latent image is formed (electrostatic latent image potential) and the developing bias voltage Vdc at the time when the photosensitive drum 1 charged at the charging bias voltage Vd is irradiated with the laser light L with the exposure amount LPW.

The maximum toner amount of the image developed on the photosensitive drum 1 changes in accordance with the developing contrast Vc. Accordingly, the maximum image density is adjusted by the developing contrast Vc. In a case where the charging bias voltage Vd and the developing bias voltage Vdc include AC components, DC components thereof are the charging bias voltage Vd and the developing bias voltage Vdc.

In the maximum density control, for example, test patterns PT each having an image area ratio of 100% are formed at a plurality of developing contrasts Vc. The developing contrast Vc of the image density serving as a target is calculated based on detection results (image densities) of those test patterns PT obtained by the image reader 50.

In the tone correction control, test patterns PT of ten tones (for example, 10%, 20%, 30%, 40%, 50%, 60%, 70%, 80%, 90%, and 100%) having different image area ratios are formed at the developing contrast Vc calculated in the maximum density control. The tone table (LUT) for correcting the gamma characteristic to obtain a target tone characteristic is created based on detection results (image densities) of such test patterns PT obtained by the image reader 50.

The image density may be detected by not only a method of detecting the test pattern PT on the intermediate transfer belt 11 through use of the image reader 50, but also a method of detecting the test pattern PT on the photosensitive drum 1. Further, the image density may be detected by forming the test pattern PT on the sheet S and reading this test pattern PT by the image reading device 110.

### Developing Device

FIG. 6 is a configuration view of the developing device 4. FIG. 6 is a cross-sectional view obtained by viewing the developing device 4 of FIG. 2 from the upper side. As described above, the developing device 4 includes the developer container 40, and the developer container 40 stores two-component developer including non-magnetic toner and magnetic carriers.

The inside of the developer container 40 is divided into a developing chamber 40a and a stirring chamber 40b by a partition wall 40c extending in the vertical direction. A screw member 42a is arranged in the developing chamber 40a. In the stirring chamber 40b, a screw member 42b is arranged. In the stirring chamber 40b, a toner supply port 43 through which toner is supplied from the toner container 8 is provided. The toner supply port 43 communicates with the toner container 8. The partition wall 40c forms, at both end portions thereof in a longitudinal direction, delivery portions 46a and 46b that are openings for allowing the developer to pass therethrough between the developing chamber 40a and the stirring chamber 40b.

Each of the screw members 42a and 42b is formed by providing a spiral blade serving as a conveying portion for the developer around a shaft (rotary shaft). Further, in the screw member 42b, in addition to the spiral blade, a stirring rib 42c is provided. The stirring rib 42c protrudes from the shaft in its radial direction, and has a predetermined width in a conveyance direction of the developer. The stirring rib 42c stirs the developer along with the rotation of the shaft.

The screw member 42a stirs and conveys the developer in the developing chamber 40a. The screw member 42b equalizes the toner density by performing automatic toner supply control (hereinafter referred to as "automatic toner replenisher (ATR) control"). That is, the screw member 42b stirs and conveys the toner supplied from the toner supply port 43 and the developer formed of toner and magnetic carriers already present in the stirring chamber 40b to equalize the toner density of the developer. Here, the toner density refers to a weight ratio of toner in the developer in the developing device 4.

The screw members 42a and 42b are arranged substantially parallel along the rotary shaft direction of the developing sleeve 41. The screw member 42a and the screw member 42b convey the developer in directions opposite to each other along the rotary shaft direction of the developing sleeve 41. In this manner, the developer circulates inside the developer container 40 through the delivery portions 46a and 46b. That is, the developer in the developing chamber 40a whose toner density is decreased due to consumption of toner in a developing step is conveyed through one of the delivery portions (for example, the delivery portion 46b) into the stirring chamber 40b.

In the stirring chamber 40b, the magnetic permeability sensor 45 is provided as a sensor for detecting the toner density of the developer. The CPU 401 determines whether or not to perform the ATR control based on an image area ratio at the time of image formation, a toner density of the developer detected through use of the magnetic permeability sensor 45, or an image density of the toner image detected through use of the image reader 50. For example, the CPU 401 performs the ATR control in a case where the toner density of the developer is lower than a predetermined toner density or in a case where the image density of the toner image is lower than a predetermined image density. In a case where the ATR control is performed, the CPU 401 controls the operation of the toner container 8 to supply the toner from the toner container 8 to the toner supply port 43. The supplied toner is mixed with the developer in the stirring chamber 40b while being stirred by the screw member 42b, and is conveyed through the other delivery portion (for example, the delivery portion 46a) into the developing chamber 40a. The developer in the developing chamber 40a is supplied to the developing sleeve 41 by the screw member 42a.

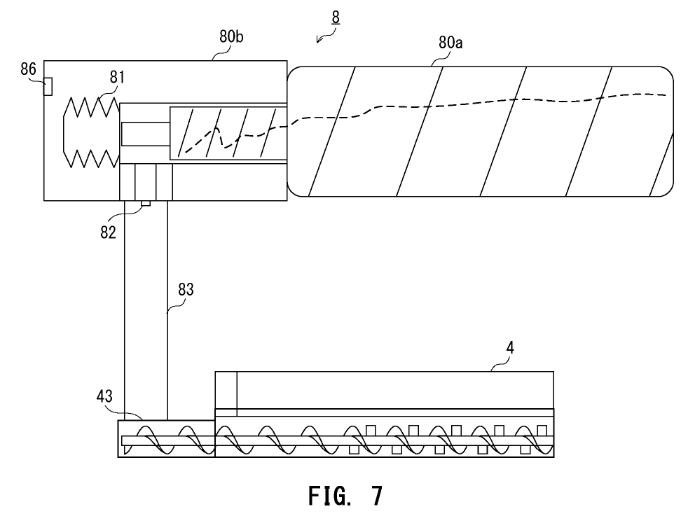

FIG. 7 is an explanatory view of the ATR control. The toner container 8 includes a discharge port 82 for discharging toner. To the discharge port 82, a replenishment conveyance path 83 for communicating with the toner supply port 43 of the developing device 4 is connected. The toner discharged from the discharge port 82 is supplied to the toner supply port 43 through the replenishment conveyance path 83.

The toner supply port 43 of the developing device 4 is provided on the most upstream side of the stirring chamber 40b and outside of a developer circulation path. At a developer conveyance member in the vicinity of the toner supply port 43, almost no developer of the developer circulation path is present, and only toner passes. The toner supply port 43 is coupled to a lower end portion of the replenishment conveyance path 83 that is a tubular member having a square cross-section.

The toner container 8 includes a container unit 80a in which a spiral groove is formed on an inner wall of a cylindrical container, and a pump unit 80b in which a pump 81 and the discharge port 82 are provided. With the container unit 80a being rotated, the toner is conveyed to the discharge port 82 of the pump unit 80b. The toner conveyed to the discharge port 82 is discharged to the replenishment conveyance path 83 through the discharge port 82 due to a change of an air pressure generated by the pump 81 for changing the volume in the toner container 8. The toner container 8 includes a container memory 86 having stored therein identification information of the toner container 8.

### Magnetic Permeability Sensor

The magnetic permeability sensor 45 provided in the developing device 4 is described. A change in toner density in the developer in the developing device 4 that is two-component developer including non-magnetic toner and magnetic carriers also causes a change in magnetic permeability corresponding to the mixing ratio between the non-magnetic toner and the magnetic carriers. Accordingly, with the magnetic permeability being detected, the toner density of the developer can be detected. The magnetic permeability sensor 45 in the first embodiment can output, as a detection result, for example, the change in magnetic permeability of the developer, that is, an output voltage corresponding to the toner density through use of an inductance of a coil.

In the magnetic permeability sensor 45, four types of bundled wires, that is, bundled wires for application of a predetermined power supply voltage (for example, 5.0 V), bundled wires for voltage application, bundled wires for grounding, and bundled wires for detection result output are wired. The magnetic permeability sensor 45 detects the magnetic permeability of the developer in the vicinity of the sensor surface. As illustrated in FIG. 6, the magnetic permeability sensor 45 is provided on the delivery portion 46a side of the stirring chamber 40b. Accordingly, the magnetic permeability sensor 45 can detect the magnetic permeability of the developer in a state in which the developer circulated from the developing chamber 40a to the stirring chamber 40b and the toner newly supplied from the toner supply port 43 are mixed and sufficiently stirred. In such a configuration, the magnetic permeability sensor 45 can prevent erroneous detection of the toner density due to insufficient stirring.

When the toner density of the developer in the developing device 4 is decreased, in the vicinity of the sensor surface of the magnetic permeability sensor 45, the ratio of the magnetic carriers included in the developer per unit volume is relatively increased, and an apparent magnetic permeability of the developer is increased. In this case, the output voltage (detection result) output from the magnetic permeability sensor 45 is increased. When the toner density of the developer in the developing device 4 is increased, in the vicinity of the sensor surface of the magnetic permeability sensor 45, the ratio of the magnetic carriers included in the developer in unit volume is relatively decreased, and the apparent magnetic permeability of the developer is decreased. In this case, the output voltage (detection result) output from the magnetic permeability sensor 45 is decreased.

The output voltage output by the magnetic permeability sensor 45 varies in accordance with a bulk density of the developer even when the developer having the same toner density is present in the vicinity of the sensor surface of the magnetic permeability sensor 45. For example, the toner charging amount of the developer decreases in a high-temperature and high-humidity environment, and hence the Coulomb repulsive force between toner particles or between carrier particles decreases, resulting in an increase in bulk density of the developer. In contrast, in a low-temperature and low-humidity environment, the toner charging amount of the developer increases, and hence the Coulomb repulsive force between toner particles or between carrier particles increases, resulting in a decrease in bulk density of the developer. That is, there is a possibility that the detection result of the magnetic permeability sensor 45 varies depending on an environmental condition (temperature and humidity). Initialization control processing is performed on the developing device 4 so that the detection result of the magnetic permeability sensor 45 does not vary depending on the environmental condition.

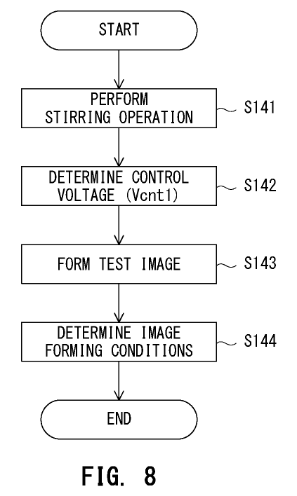

FIG. 8 is a flow chart for illustrating the initialization control processing of the developing device 4. With the initialization control processing being performed, as long as the toner density of the developer is the same, the magnetic permeability sensor 45 can output the same output voltage regardless of the environmental condition.

In a case where a new developing device 4 is mounted, the CPU 401 performs a stirring operation for the developer for a predetermined time period (for example, one minute) to stabilize the charging amount of the developer stored in the developing device 4 (Step S141). At this time, in order to prevent the toner in the developer from flying to the photosensitive drum 1 to change the toner density, a predetermined voltage is applied to the developing sleeve 41 and the photosensitive drum 1 to provide a predetermined potential difference.

The CPU 401 changes the control voltage to be applied to the magnetic permeability sensor 45 in increments of, for example, 0.1 V within a predetermined range, and acquires the output voltage of the magnetic permeability sensor 45 output in accordance therewith. In the developing device 4, developer whose toner density has been adjusted in advance to a target toner density at the time of factory shipment is stored. The CPU 401 sets a control voltage at the time of acquiring a predetermined output voltage (in this case, 2.0 V) corresponding to the target toner density as a control voltage (Vcnt1) to be applied to the magnetic permeability sensor 45 in order to appropriately detect the toner density (Step S142). The magnetic permeability sensor 45 to which the control voltage (Vcnt1) is applied can output the same output voltage regardless of the environmental condition as long as the toner density of the developer is the same.

The CPU 401 forms a plurality of fixed test images each having an area ratio of 60% on the intermediate transfer belt 11 while changing the image forming conditions (Step S143). In this case, as the image forming conditions, the charging bias voltage Vd is set and fixed to −600 V and the developing bias voltage Vdc is set and fixed to −450 V, and the exposure amount of the laser light L emitted by the exposing device 3 is changed in five levels. The test image is an image for detecting the image density of the toner image.

The CPU 401 detects the image density of the test image from the detection result of the test image obtained by the image reader 50. The CPU 401 determines the exposure amount at the time when the detection result (image density value) of the image density becomes a predetermined value (in this case, 0.90) as an exposure amount LPW-ATR of the image forming conditions at the time of forming the test image when toner is supplied in accordance with the detection result obtained by the image reader 50. The rest of the image forming conditions are the charging bias voltage Vd of −600 V and the developing bias voltage Vdc of −450 V.

The CPU 401 determines the image forming conditions (charging bias voltage of −600 V, developing bias voltage of −450 V, and exposure amount LPW-ATR) to be used to form the test image in a case where toner is supplied in accordance with the detection result obtained by the image reader 50 (Step S144). The image forming condition adjusted in the processing step of Step S143 is not limited to the exposure amount, and is only required to be a parameter that affects consumption of toner, such as the charging bias voltage Vd or the developing bias voltage. Further, in the processing step of Step S143, those conditions may be adjusted in combination.

### ATR Control

In the ATR control, the toner supply amount is derived based on the result of detecting the toner amount or state in the developing device 4. The toner supply amount controller 150 automatically supplies toner to the developing device 4 at an appropriate timing. The appropriate timing is, for example, a timing at which the toner density is decreased due to consumption of toner by printing.

In the ATR control in the first embodiment, the supply amount based on an estimated value of a toner consumption amount using a video count value and the supply amount based on the detection result of the toner density obtained by the magnetic permeability sensor 45 are added to derive the toner supply amount. Toner supply amount control performed by the estimated value of the toner consumption amount using the video count value is referred to as "video count supply control." Toner supply amount control performed by the supply amount based on the detection result of the toner density using the magnetic permeability sensor 45 is referred to as "inductance supply control."

At this time, the target value of the toner density (target toner density) to be detected through use of the magnetic permeability sensor 45 is not constant and is always corrected. The target toner density is corrected by appropriately performing control of forming, on the intermediate transfer belt 11, a fixed test image having an area ratio of 60% with the image forming conditions determined by the initialization control processing, and detecting the image density of the test image by the image reader 50. Such control of the target toner density is referred to as "ATR patch control."

In the ATR patch control, the fixed test image is formed at the same image forming condition, and hence the image density detected by the image reader 50 reflects a charging state (Q/M) of the toner. The charging state (Q/M) of the toner is a toner charging amount per unit mass. As the charging state (Q/M) of the toner becomes smaller, the detected image density becomes higher, and as the charging state (Q/M) of the toner becomes larger, the detected image density becomes lower.

In the first embodiment, an image for detection for the ATR patch control (hereinafter referred to as "ATR patch control pattern") is formed at predetermined intervals. For example, the ATR patch control pattern is formed every time a predetermined number of sheets S are passed (for example, every 200 sheets in A4 size). Further, the ATR patch control pattern is formed with the image forming conditions determined in the initialization control processing of the developing device 4. In the first embodiment, the image forming conditions are the charging bias voltage of −600 V, the developing bias voltage of −450 V, and the exposure amount LPW-ATR. In the first embodiment, the image density serving as a target of the ATR patch control pattern is set to about 0.90. This setting is made because this image density range is suitable for detection of the charging state (Q/M) of the toner.

### Toner Supply Amount Controller

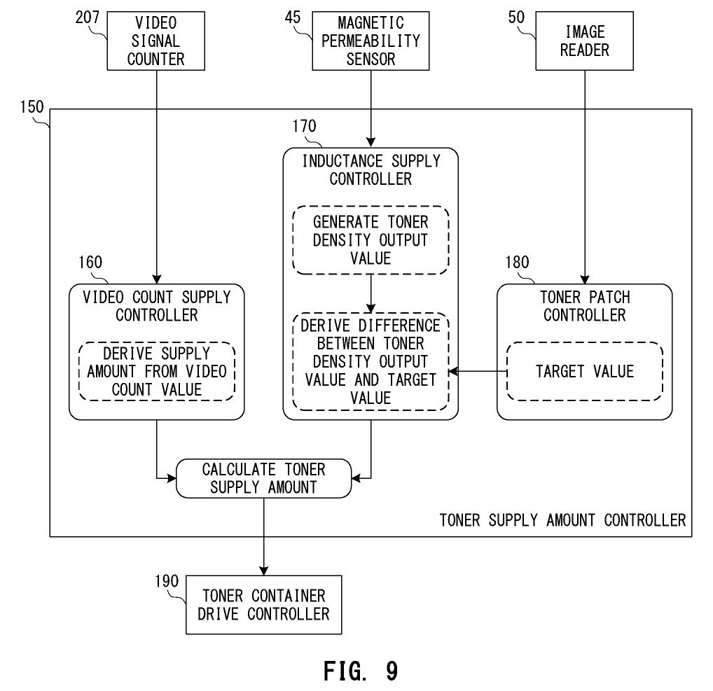

FIG. 9 is an explanatory view of the toner supply amount controller 150. As described above, the toner supply amount is a sum value of the supply amounts calculated by the video count supply control and the inductance supply control. The toner supply amount is calculated through use of the mass of the toner to be supplied (in units of "mg") as units. The toner supply amount controller 150 includes a video count supply controller 160, an inductance supply controller 170, and a toner patch controller 180. The toner supply amount controller 150 is connected to the video signal counter 207, the magnetic permeability sensor 45, the image reader 50, and a toner container drive controller 190.

In the video count supply control, the video count supply controller 160 acquires a video count value generated in the video signal counter 207. The video count supply controller 160 derives the supply amount of the toner by converting the acquired video count value into the mass of toner to be supplied through use of a conversion table held in advance.

In the inductance supply control, the inductance supply controller 170 acquires the output voltage value corresponding to the toner density from the magnetic permeability sensor 45. The inductance supply controller 170 performs AD conversion of the acquired output voltage value to generate an 8-bit digital signal value. This digital signal value is hereinafter referred to as "toner density output value." The supply amount is derived from the difference between the toner density output value and a target value (target toner density) thereof. The target value is generated by the toner patch controller 180. The toner patch controller 180 determines the target value in accordance with the output value of the image reader 50.

The toner supply amount controller 150 adds the supply amounts derived from the video count supply controller 160 and the inductance supply controller 170 to derive the amount of toner to be supplied to the developing device 4. The toner supply amount controller 150 transmits the derived toner supply amount to the toner container drive controller 190. The toner container drive controller 190 operates the toner container 8 to supply toner of the toner supply amount to the developing device 4.

The video count supply control is feedforward control, and the supply amount is always a positive value. The inductance supply control is feedback control performed by detecting the toner density in the developing device 4 by the magnetic permeability sensor 45, and the supply amount may take any one of a positive value and a negative value. The excess or deficiency of the supply amount derived in the video count supply control is adjusted by the supply amount derived by the inductance supply control, and hence it is possible to suppress variations in toner density in the developing device 4.

### Empty Determination, Replacement Determination, and Mounting Determination for Toner Container

In the first embodiment, it is assumed that the amount of developer stored in the developing device 4 is 160 g, the amount of toner consumed by the A4 size sheet having the image area ratio of 100% is 0.3 g, and a target TD ratio that is a target value of a detection result (TD ratio) obtained by the magnetic permeability sensor 45 representing the toner density is 8%.

Empty determination for the toner container 8 is described. Here, a state in which there is no toner in the toner container 8 (state in which the toner container 8 is empty) means that the amount of toner in the toner container 8 is smaller than a predetermined amount. When the amount of toner in the toner container 8 is smaller than the predetermined amount, even when a supply operation of supplying toner to the developing device 4 is performed, the amount of toner supplied to the developing device 4 is remarkably reduced, and thus the detection result (TD ratio) obtained by the magnetic permeability sensor 45 does not return to the target TD ratio. Accordingly, when, regardless of performing the supply operation, the detection result obtained by the magnetic permeability sensor 45 is lower than the target TD ratio by 1% or more even when images are successively printed on a predetermined number of (in this case, five) sheets S, the toner supply amount controller 150 determines that there is no toner in the toner container 8. In a case where the toner container 8 is determined to be empty, the CPU 401 displays on the display unit 411 a message (for example, "Please replace the toner container") to instruct a user to replace the toner container 8, and execution of a printing operation is inhibited. The toner supply amount controller 150 may determine that the toner container 8 is empty when, after the toner container 8 itself is rotated, there is no change in detection result of the toner density (TD ratio) inside the developing device 4 after the supply operation.

The replacement determination for the toner container 8 is described. The toner supply amount controller 150 can detect a state (open state and closed state) of a door to be opened and closed for replacement of the toner container 8. In a case where the open/close detection result of the door changes from a closed state in which the door is closed to an open state in which the door is open, and then the open/close detection result changes to the closed state again, the toner supply amount controller 150 reads the identification information from the container memory 86 of the toner container 8 and compares the read identification information with the identification information stored in the memory 490. The toner supply amount controller 150 determines that the toner container 8 has been replaced in a case where the identification information read out from the container memory 86 is different from the identification information stored in the memory 490. The CPU 401 stores the identification information of the toner container 8 after the replacement into the memory 490 after it is determined that the toner container 8 is replaced with a new toner container 8.

Further, the toner supply amount controller 150 may determine that the toner container 8 has been replaced by detecting mounting of the toner container 8 under a state in which a message of an instruction to replace the toner container 8 is displayed on the display unit 411. The mounting of the toner container 8 is determined by, for example, a change of a detection result obtained by a sensor for detecting presence or absence of the toner container 8. In a case where the detection result obtained by the sensor has changed from a state in which the toner container is not mounted to a state in which the toner container is mounted, the toner supply amount controller 150 determines that the toner container 8 is mounted.

Further, the toner supply amount controller 150 may determine that the toner container 8 has been replaced in a case where the user has input that the toner container 8 has been replaced through the input unit 412 under a state in which a message of an instruction to replace the toner container 8 is displayed on the display unit 411. In this case, for example, a message such as "Has the toner container been replaced?" is displayed on the display unit 411, and the user inputs that the toner container 8 has been replaced in response to the message. The replacement determination for the toner container 8 is not limited to those configurations, and may be performed by adopting a publicly-known replacement detection method.

Further, the image forming apparatus 100 has a possibility that the toner density (TD ratio) of the developer in the developing device 4 greatly varies also when the toner container 8 is removed from the mounting unit and is mounted again. Accordingly, when there is a possibility that the toner container 8 has been mounted, it may be determined that the toner container 8 has been replaced. In the following, a determination method of determining the mounting of the toner container 8 is described. The toner supply amount controller 150 can determine that the toner container 8 has been mounted when there is a change from a state in which communication to and from the container memory 86 cannot be established to a state in which communication to and from the container memory 86 can be established. Further, the toner supply amount controller 150 can determine that there is a possibility that the toner container 8 has been mounted by detecting the opening and closing of the door. The toner supply amount controller 150 may determine that the toner container 8 has been replaced when there is a possibility that the toner container 8 has been mounted.

### Change of Toner Density TD ratio along with Mounting of Toner Container

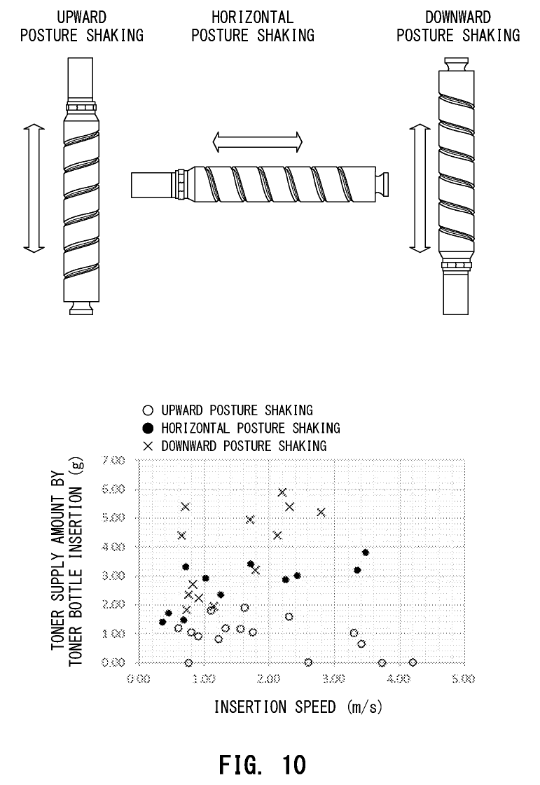

In a case where the toner container 8 is removed and inserted, there is a possibility that oversupply of toner occurs. FIG. 10 is an explanatory diagram of the supply amount of toner to be supplied to the developing device 4. FIG. 10 shows, as an example, a relationship between a speed of insertion of the new toner container 8 to the mounting unit and the supply amount of toner to be supplied to the developing device 4 immediately after the new toner container 8 is mounted. The white circle plot indicates a toner supply amount in a case in which the toner container 8 is mounted after the toner container 8 is shaken ten times while one side on which the discharge port 82 is present of the toner container 8 in the longitudinal direction is directed upward in the gravity direction (referred to as "upward posture shaking"). The black circle plot indicates a toner supply amount in a case in which the toner container 8 is mounted after the toner container 8 is shaken ten times while the longitudinal direction of the toner container 8 is kept substantially parallel with the horizontal direction (referred to as "horizontal posture shaking"). The "×" plot indicates a toner supply amount in a case in which the toner container 8 is mounted after the toner container 8 is shaken ten times while the one side on which the discharge port 82 is present of the toner container 8 in the longitudinal direction is directed downward in the gravity direction (referred to as "downward posture shaking").

As shown in FIG. 10, the toner supply amount from the toner container 8 greatly varies depending on the state (posture) of the toner container 8 before the toner container 8 is mounted. It is understood that, in a case where the toner container 8 is mounted after downward posture shaking is performed, oversupply of toner may occur. The minimum toner supply amount in normal toner supply control was 0.25 g.

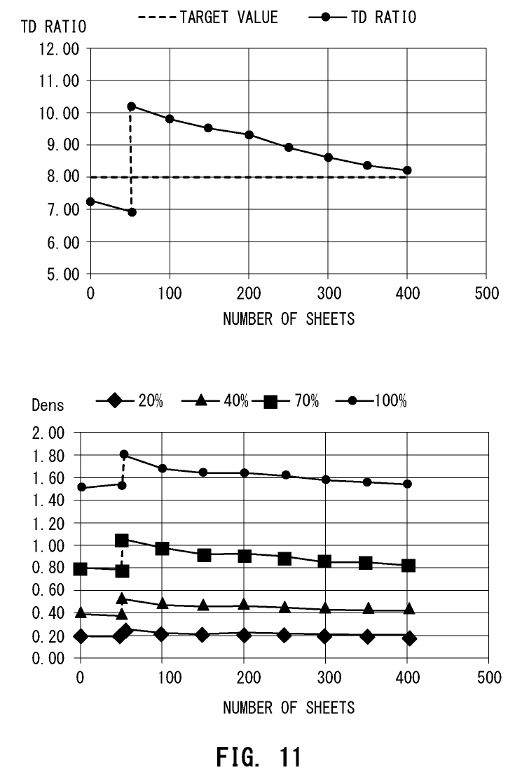

FIG. 11 is an explanatory graph of the change in toner density exhibited when oversupply of toner has occurred due to mounting of the toner container 8. In this example, the toner container 8 is replaced while the number of sheets subjected to printing is between the fiftieth sheet and the fifty-first sheet, and toner of about 5.0 g is oversupplied to the developing device 4 at this time. The toner density (TD ratio) of the developing device 4 in a case where the toner container 8 is determined to be empty is 7.0%. The toner of 5.0 g is supplied in a case where the toner container 8 is inserted. With this, the toner density (TD ratio) of the developing device 4 is changed to 10.3%. This change in toner density (TD ratio) causes the image density of the printed image to greatly change. The influence of the change in image density becomes more pronounced as an image having a higher image density is printed.

The difference in toner density (TD ratio) of the developing device 4 when the toner container 8 is determined to be empty is described.

For example, after the toner density (TD ratio) of the developer in the developing device 4 is detected as 7%, which is lower by 1% or more than the target TD ratio of 8%, images are printed on five sheets S by the time the toner container 8 is determined to be empty. The reason why the toner container 8 is determined to be empty when the toner density (TD ratio) is successively 7% or less while the images are printed on five sheets S is that the toner density (TD ratio) has fluctuations of about ±1.0% depending on the detection accuracy of the magnetic permeability sensor 45. The toner density (TD ratio) detected by the magnetic permeability sensor 45 fluctuates, and hence there is a possibility that the toner container 8 is erroneously determined to be empty when the number of sheets S on which the images have been printed is small.

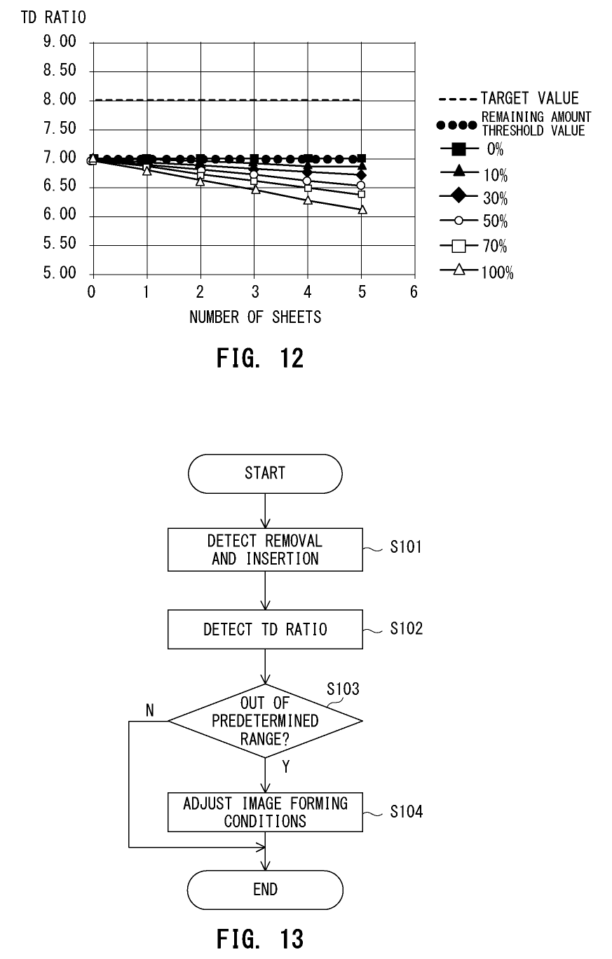

FIG. 12 is an explanatory graph of the toner density (TD ratio) at the time when the toner container 8 is determined to be empty. As shown in FIG. 12, when the image signal value (area ratio) of the image to be printed changes from 0% and 100%, the toner density (TD ratio) at the time of empty determination of the toner container 8 also changes from 7.0% to 6.1%. The toner density (TD ratio) further has fluctuations of ±1.0% depending on the detection accuracy of the magnetic permeability sensor 45. That is, toner cannot be supplied by the toner supply operation immediately before the toner container 8 is determined to be empty, and hence the toner density (TD ratio) deviates more greatly from the target TD ratio as the image signal value (area ratio) of the image to be printed becomes larger.

### Determination on Execution of Image Adjustment Control After Removal and Insertion of Toner Container

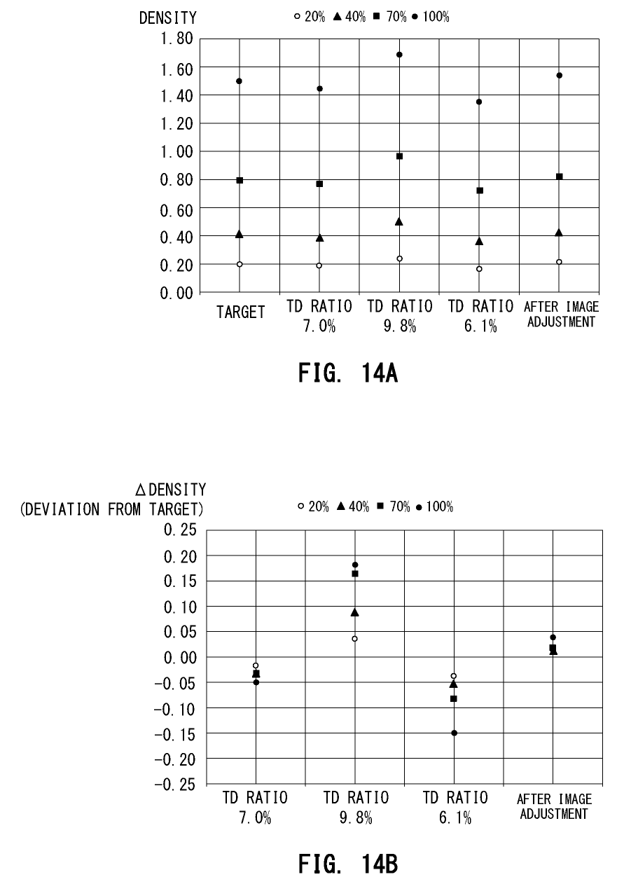

Causes of great deviation of the toner density (TD ratio) from the target value after removal and insertion of the toner container 8 include a case in which oversupply of toner has occurred due to removal and insertion of the toner container 8 and a case in which the image area ratio of the image printed immediately before the toner container 8 is determined to be empty is large. In the first embodiment, when the toner density (TD ratio) greatly deviates from the target toner density (target TD ratio) after the toner container 8 is mounted, determination processing of determining whether or not to perform the image adjustment control is performed so as to adjust the image density of the image to be printed immediately after the toner container 8 is mounted to the target image density. FIG. 13 is a flow chart for illustrating the determination processing of determining whether or not to perform the image adjustment control.

In a case where the CPU 401 determines that the toner container 8 is empty by the toner supply amount controller 150, the CPU 401 urges the user to replace the toner container 8. The method of urging the user to replace the toner container 8 is performed by, for example, display of a message on the display unit 411 or notification to a support center via a network. The user performs work of replacing the toner container 8 or work of checking whether the toner container 8 is empty in accordance with this instruction.

The CPU 401 detects removal and insertion (mounting) of the toner container 8 by the toner supply amount controller 150 (Step S101). As described above, the CPU 401 is not required to detect the actual removal and insertion (mounting) of the toner container 8, and the CPU 401 may determine that the removal and insertion of the toner container 8 have been detected when the possibility that the toner container 8 has been removed and inserted is detected.

The CPU 401 performs a developer stirring operation (idle rotation) of the developing device 4 until the influence of toner supplied by mounting the toner container 8 is reflected in the detection result obtained by the magnetic permeability sensor 45. The CPU 401 acquires the toner density (TD ratio) that is the detection result obtained from the magnetic permeability sensor 45 after the developer stirring operation of the developing device 4 (Step S102). The developer stirring operation (idle rotation) of the developing device 4 is not limited to being carried out immediately after the removal and insertion of the toner container 8 are detected, and is only required to be performed by the time the printing operation based on the print job is started after the removal and insertion of the toner container 8 are detected. For example, the developer stirring operation (idle rotation) of the developing device 4 may be performed immediately before the first printing operation based on the print job after the removal and insertion of the toner container 8 are detected. Further, the toner density (TD ratio) of the developing device 4 may be detected by, other than using the magnetic permeability sensor 45, for example, forming the ATR patch control pattern and performing detection based on the detection value of the ATR patch control pattern detected by the image reader 50. When the TD ratio decreases, the density of the ATR patch control pattern becomes higher, and when the TD ratio increases, the density of the ATR patch control pattern becomes lower. The CPU 401 may refer to correlation data between the density of the ATR patch control pattern and the TD ratio stored in advance in the memory 490 to detect the TD ratio from the density of the ATR patch control pattern.

The CPU 401 determines whether or not the detected toner density (TD ratio) of the developing device 4 is out of a predetermined range (Step S103). That is, it is determined whether or not the toner density (TD ratio) is within a range between two different threshold values. In the first embodiment, the predetermined range of the toner density (TD ratio) is set to 6.5% or more and 7.2% or less.

In a case where the toner density (TD ratio) is less than 6.5%, because the toner container 8 is started to be detected to be empty at 7.0%, it is determined that the toner is greatly consumed immediately before the toner container 8 is replaced, and the image density becomes lower when the image is formed with this image forming condition being kept. When the toner density (TD ratio) is more than 7.2%, it is determined that oversupply of toner occurs due to removal and insertion of the toner container 8, and the image density becomes higher when the image is formed with this image forming condition being kept. The oversupply of toner greatly affects the image density change more than the toner consumption, and hence, in the first embodiment, the predetermined range is set such that a range in a direction in which the toner density (TD ratio) becomes larger is smaller. In the first embodiment, the image density variations from a state in which the toner container 8 has become empty are focused, and there has been described an example in which 7.0%, which is the toner density (TD ratio) of the developing device 4 when the toner container 8 is determined to be empty, is used as a reference, but 8%, which is the target TD ratio, may be used as a reference.

When it is determined that the toner density (TD ratio) of the developing device 4 is out of the predetermined range (Step S103: Y), the CPU 401 forms a test pattern PT, adjusts the image forming conditions based on a reading result of the test pattern PT obtained by the image reader 50 (Step S104), and ends the processing. This is because, when the image is formed without changing the image forming conditions while the toner density (TD ratio) of the developing device 4 is maintained out of the predetermined range, the image density of the printed image greatly deviates from the target image density. Further, there may be employed a configuration of performing display of urging the user to execute adjustment of the image forming conditions on the display unit 411 without automatically forming the test pattern PT. The test pattern PT is formed in response to an instruction to adjust the image forming conditions given by the user. In the first embodiment, the adjustment of the image forming conditions may be determined by, other than determination based on whether or not the toner density (TD ratio) of the developing device 4 is out of the predetermined range, determination based on whether or not a change amount of the toner density (TD ratio) of the developing device 4 with respect to the number of sheets S subjected to printing is out of a predetermined range.

When it is determined that the toner density (TD ratio) of the developing device 4 is not out of the predetermined range (Step S103: N), that is, when the toner density (TD ratio) of the developing device 4 is within the predetermined range, the CPU 401 ends the processing without adjusting the image forming conditions. At this time, no test pattern PT is formed. This is because, when the toner density (TD ratio) of the developing device 4 is within the predetermined range, even when an image is formed without changing the image forming conditions, the image density of the printed image does not greatly deviate from the target image density. The productivity is maintained because the image forming conditions are not adjusted.

FIGS. 14A and 14B are explanatory graphs of effects obtained by the first embodiment described above. FIG. 14A shows, as an example, the image density after the toner container 8 is replaced when the image density specified by the image signal 415 is 20%, 40%, 70%, or 100%. FIG. 14A shows, as an example, the target image density (target), the image density in the case in which the toner density (TD ratio) of the developing device 4 is 7.0%, 9.8%, or 6.1%, and the image density in a case after image adjustment.

FIG. 14B shows, as an example, a deviation (Δ density) of each of the image densities in the case in which the toner density (TD ratio) is 7.0%, 9.8%, and 6.1% and the image density in the case after image adjustment, with respect to the target image density of FIG. 14A. It is understood that, when the toner density (TD ratio) immediately after the toner container 8 is replaced is 6.1%, unless the image forming conditions are adjusted by image adjustment, the image density of the formed image becomes lower than the target image density (target). Further, it is understood that, when the toner density (TD ratio) immediately after the toner container 8 is replaced is 9.8%, unless the image forming conditions are adjusted by image adjustment, the image density of the formed image becomes higher than the target image density (target).

As described above, in the first embodiment, the image forming conditions are adjusted when the toner density (TD ratio) of the developing device 4 becomes out of the predetermined range or the change amount of the toner density (TD ratio) of the developing device 4 with respect to the number of sheets S subjected to printing becomes out of the predetermined range, such as in the case after the removal and insertion of the toner container 8. Accordingly, the image can be formed at an image density close to the target image density. The accuracy of the image density adjustment in this case becomes an accuracy by adjustment of the image forming condition to be executed.

### Modification Example

In the description above, after the toner container 8 is mounted, whether or not to form the test pattern PT to update the image forming conditions based on the toner density (TD ratio) shown in the processing step of Step S102 is controlled. However, there may be employed a configuration in which, when it is determined that the toner container 8 mounted to the mounting unit is replaced with a new toner container 8, the test pattern PT is formed to update the image forming conditions. This is because replacement with a new toner container 8 is a situation that most frequently causes oversupply of toner. With this configuration, even when the toner density in the developing device 4 greatly varies when a new toner container 8 is mounted, the image density can be controlled with high accuracy.

### Second Embodiment

In the first embodiment, the image forming conditions are adjusted after the toner container 8 is mounted. With the image forming conditions being adjusted, even when the toner density (TD ratio) greatly deviates from the target toner density, a deviation amount of the image density of the printed image from the target image density is reduced.

However, when the image density is matched with the target image density through adjustment of the image forming conditions under a state in which the toner density (TD ratio) of the developing device 4 greatly deviates from the target toner density, it is required to adjust the image forming conditions again through the subsequent toner supply control. This is because, when the toner density (TD ratio) of the developing device 4 is brought closer to the target toner density through the toner supply control, without adjustment of the image forming conditions, the image density of the printed image deviates from the target image density.

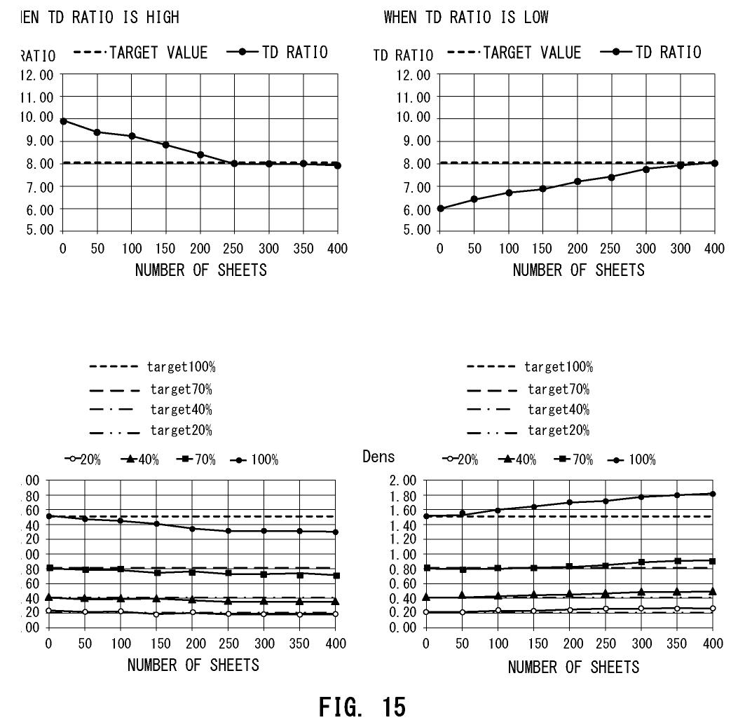

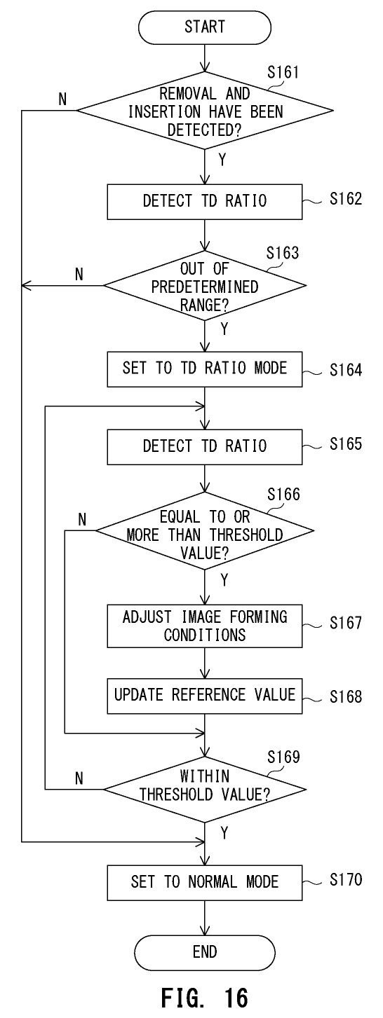

FIG. 15 shows explanatory graphs of transitions of the toner density (TD ratio) and the image density after the toner container 8 is replaced. FIG. 15 shows, as an example, transitions of the toner density (TD ratio) and the image density with respect to the number of sheets S subjected to printing, for each of a case in which the toner density (TD ratio) is high and a case in which the toner density (TD ratio) is low. Successive printing to fifty sheets S is repeated eight times, and measurement results of the image densities of the images printed on the first sheet S and the fiftieth sheet S of each case are shown as an example. The number of sheets S subjected to printing is counted through use of the number of sheets at the time when the toner container 8 has been replaced as a reference.

As described in the first embodiment, even when the toner density (TD ratio) greatly deviates, the image density can be matched with the target image density through adjustment of the image forming conditions, and hence the image density of the image printed on the first sheet S matches the target image density. However, as the number of sheets subjected to printing is increased, along with the change of the toner density (TD ratio) in a direction of coming closer to the target toner density through the toner supply control, the image density transitions while deviating from the target image density. The followability of the toner density (TD ratio) to the target toner density is dependent on the image signal value (area ratio) of the printed image, and hence cannot be defined by the number of sheets subjected to printing.

In a second embodiment of the present disclosure, until the toner density (TD ratio) follows the target toner density after the toner container 8 is replaced, the image forming conditions are adjusted in accordance with the change amount of the toner density (TD ratio). In this manner, deviation of the image density from the target image density is suppressed. The timing to perform normal adjustment of the image forming conditions in the second embodiment is, because following is possible by the toner supply control to some extent, the timing of back rotation in a case in which the number of sheets S subjected to printing has exceeded 2,000 sheets or more.

FIG. 16 is a flow chart for illustrating determination processing of determining whether or not to perform the image adjustment control in the second embodiment. In the processing of FIG. 16, the timing to adjust the image forming conditions is determined based on the change amount of the toner density (TD ratio) after the removal and insertion of the toner container 8.

The CPU 401 determines whether the removal and insertion of the toner container 8 have been detected by the toner supply amount controller 150 (Step S161). The CPU 401 is not required to detect the actual removal and insertion of the toner container 8, and is only required to detect the possibility that the toner container 8 has been removed and inserted to determine that the removal and insertion of the toner container 8 have been detected.

When the removal and insertion of the toner container 8 have been detected (Step S161: Y), the CPU 401 detects the toner density (TD ratio) (Step S162). Then, in the second embodiment, when the removal and insertion of the toner container 8 have been detected, the adjustment of the image forming conditions is always carried out. As described in the first embodiment, whether to carry out the adjustment of the image forming conditions may be determined in accordance with the detected toner density (TD ratio).

Next, the CPU 401 determines whether or not the detected toner density (TD ratio) is out of the predetermined range (Step S163). The predetermined range of the toner density (TD ratio) in the second embodiment is set to 6.5% or more and 7.2% or less. When the detected toner density (TD ratio) is out of the predetermined range (Step S163: Y), the CPU 401 sets a "toner density (TD ratio) mode" in which whether to carry out adjustment of the image forming conditions is determined based on the toner density (TD ratio) (Step S164). The CPU 401 detects the toner density (TD ratio) during image formation (Step S165). In order to suppress variations of the detection result of the toner density (TD ratio) obtained by the magnetic permeability sensor 45, an average value of the toner densities (TD ratios) at the time of printing onto a plurality of sheets S may be used as the toner density (TD ratio) in the processing step of Step S165. Further, the toner density (TD ratio) of the developing device 4 may be detected by, other than using the magnetic permeability sensor 45, for example, forming the ATR patch control pattern and performing detection based on the detection value of the ATR patch control pattern obtained by the image reader 50.

The CPU 401 determines whether or not a difference between the detected toner density (TD ratio) and the reference value of the toner density (TD ratio) is equal to or more than a threshold value (Step S166). An initial reference value of the toner density (TD ratio) is the toner density (TD ratio) detected immediately after the toner container 8 is removed and inserted or the toner density (TD ratio) detected when the image forming conditions are first adjusted after the toner container 8 is removed and inserted. That is, the initial reference value of the toner density (TD ratio) is the toner density (TD ratio) detected in Step S162. In the second embodiment, the threshold value of the difference from the reference value of the toner density (TD ratio) when the toner density (TD ratio) is high is set to 0.5%. The threshold value of the difference from the reference value of the toner density (TD ratio) when the toner density (TD ratio) is low is set to 0.4%.

When the difference of the toner density (TD ratio) is equal to or more than the threshold value (Step S166: Y), the CPU 401 adjusts the image forming conditions (Step S167). In the second embodiment, in order to avoid a change in image density in the same print job, the image forming conditions are adjusted in the back rotation of the image formation. However, the timing to adjust the image forming conditions is not limited to the timing of the back rotation of the image formation, and may be the timing between when an image is formed on one sheet and when an image is formed on another sheet, in a case in which images are successively formed.

The CPU 401 updates the toner density (TD ratio) used when the image forming conditions are adjusted in the processing step of Step S167 as a reference value of the toner density (TD ratio) (Step S168). When the difference of the toner density (TD ratio) is less than the threshold value (Step S166: N), or after the reference value is updated, the CPU 401 determines whether or not the difference between the reference value of the toner density (TD ratio) and the target toner density is within a threshold value (Step S169). That is, the CPU 401 determines whether or not the toner density (TD ratio) has been able to follow the target toner density. The threshold value for the difference between the reference value of the toner density (TD ratio) and the target toner density is, for example, 0.5% when the toner density (TD ratio) is high, and is, for example, 0.4% when the toner density (TD ratio) is low.

When the difference between the reference value and the target toner density is not within the threshold value (Step S169: N), the CPU 401 repeatedly performs the processing step of Step S165 and the subsequent steps. When the difference between the reference value and the target toner density is within the threshold value (Step S169: Y), the toner density (TD ratio) is in a state of following the target toner density. Accordingly, in this case, the CPU 401 sets the determination on whether or not to adjust the image forming conditions to a "normal mode" (Step S170). In this manner, the image forming conditions are thereafter adjusted in back rotation in a case in which the number of sheets S subjected to image formation has exceeded 2,000 sheets or more.

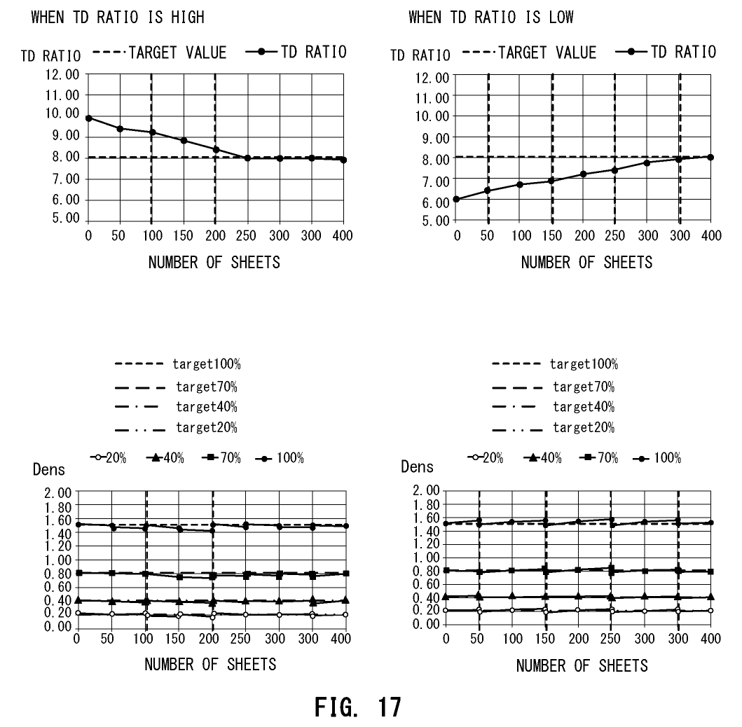

FIG. 17 shows explanatory graphs of effects obtained by the second embodiment described above. FIG. 17 shows explanatory graphs of transitions of the toner density (TD ratio) and the image density after the toner container 8 is replaced, similar to FIG. 15. FIG. 17 represents how the density transition shown in FIG. 15 is improved by executing adjustment of the image forming conditions in accordance with the change amount of the toner density (TD ratio) until the toner density (TD ratio) follows the target toner density after the toner container 8 is replaced.

When the toner density (TD ratio) is high, the image forming conditions are adjusted in back rotation after the 100th sheet and the 200th sheet are subjected to printing. When the toner density (TD ratio) is low, the image forming conditions are adjusted in back rotation after the 50th sheet, the 150th sheet, the 250th sheet, and the 350th sheet are subjected to printing. It is understood that the transition of the image density shown in FIG. 17 is reduced in fluctuations of the image density than the transition of the image density shown in FIG. 15.

As described above, in the second embodiment, it is possible to prevent the image density of the printed image from deviating from the target image density by appropriately adjusting the image forming conditions even when toner supply is performed so that the toner density (TD ratio) comes closer to the target toner density after the toner container 8 is replaced.

As described above, the image forming apparatus 100 of the first and second embodiments can control the image density with high accuracy even when the toner density in the developing device 4 abruptly changes at the time of removal and insertion of the toner container 8. In this manner, the image density of the printed image is kept at the target image density.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-065002, filed Apr. 10, 2025, which is hereby incorporated by reference herein in its entirety.

What is claimed is:

1. An image forming apparatus comprising:
an image forming unit which includes a developing device configured to store developer including toner and carriers, the developing device being configured to form an image using the toner of the developing device;
a detector which is provided in the developing device, the detector being configured to detect a toner density of the developer in the developing device;
an image reader configured to read a test image formed by the image forming unit;
a mounting unit to which a toner container storing toner to be supplied to the developing device is to be mounted; and
a processor configured to:
adjust, in a case where the toner container is mounted to the mounting unit, an image forming condition for controlling a density of an image to be formed by the image forming unit before image formation based on a job is started;
control, in a case where the toner container is mounted to the mounting unit, whether to form the test image based on the toner density detected by the detector after the image formation based on the job is started; and
update the image forming condition based on a reading result of the test image read by the image reader.

2. The image forming apparatus according to claim 1, wherein the processor is configured to control, in a case where the toner container is mounted to the mounting unit, whether to form the test image based on a change amount of the toner density detected by the detector.

3. The image forming apparatus according to claim 1, wherein the processor is configured to control the image forming unit to form the test image in a case where a difference between the toner density detected by the detector and a reference value is larger than a threshold value after the image formation based on the job is started.

4. The image forming apparatus according to claim 3, wherein the processor is configured to update the reference value in a case where the image forming condition is adjusted based on the reading result of the test image read by the image reader after the image formation based on the job is started.

5. The image forming apparatus according to claim 1, wherein the processor is configured to control, in a case where the toner density detected by the detector is out of a target range of the toner density before the image formation based on the job is started, the image forming unit to form the test image based on the toner density detected by the detector after the image formation based on the job is started.

6. The image forming apparatus according to claim 5, wherein the processor is configured to control, in a case where the toner density detected by the detector is within the target range of the toner density before the image formation based on the job is started, the image forming unit to form the test image based on the number of sheets subjected to printing by the image forming unit after the image formation based on the job is started.

7. An image forming apparatus comprising:
an image forming unit which includes a developing device configured to store developer including toner and carriers, the developing device being configured to form an image using the toner of the developing device;
a detector which is provided in the developing device, the detector being configured to detect a toner density of the developer in the developing device;
an image reader configured to read a test image formed by the image forming unit;
a mounting unit to which a toner container storing toner to be supplied to the developing device is to be mounted; and
a processor configured to:
control, in a case where the toner container is mounted to the mounting unit, the image forming unit to form the test image before image formation based on a job is started;
control the image forming unit to form an image for detection, and detect the toner density of the developer in the developing device based on a reading result of the image for detection read by the image reader; and
adjust an image forming condition for controlling a density of an image to be formed by the image forming unit based on a reading result of the test image read by the image reader.

8. The image forming apparatus according to claim 7, wherein the processor is configured to control, after the image formation based on the job is started, the image forming unit to form the test image based on a change amount of the toner density detected by the detector.

9. The image forming apparatus according to claim 7, wherein the processor is configured to control the image forming unit to form the test image in a case where a difference between the toner density detected by the detector and a reference value is larger than a threshold value after the image formation based on the job is started.

10. The image forming apparatus according to claim 9, wherein the processor is configured to update the reference value in a case where the image forming condition is adjusted based on the reading result of the test image read by the image reader after the image formation based on the job is started.

11. The image forming apparatus according to claim 7, wherein the processor is configured to control, in a case in which the toner container is mounted to the mounting unit, in a case where the toner density detected by the detector is out of a target range of the toner density before the image formation based on the job is started, the image forming unit to form the test image based on the toner density detected by the detector after the image formation based on the job is started.

12. The image forming apparatus according to claim 11, wherein the processor is configured to control, in a case where the toner density detected by the detector is within the target range of the toner density before the image formation based on the job is started, the image forming unit to form the test image based on the number of sheets subjected to printing by the image forming unit after the image formation based on the job is started.
